(19) United States
(12) Patent Application Publication
(10) Pub. No.: US 2006/0129987 A1
(43) Pub. Date: Jun. 15, 2006

(54) Apparatus, system, and method for accessing management data

(76) Inventors: Linda Van Patten Benhase, Tucson, AZ (US); Douglas William Dewey, Tucson, AZ (US); Shah Mohammad Rezaul Islam, Tucson, AZ (US)

Correspondence Address: KUNZLER & ASSOCIATES, 8 EAST BROADWAY, SUITE 600, SALT LAKE CITY, UT, 84111, US

(21) Appl. No.: 11/014,396

(22) Filed: Dec. 15, 2004

(51) Int. Cl. G06F 9/44

(52) U.S. Cl. 717/121

(57) ABSTRACT

An apparatus, system, and method are disclosed for accessing management data. A management application program inference stores and retrieves management data in a dedicated management data logical volume of a data storage device. The management data is inaccessible except through the management application program interface. The management data is used to initialize and configure one or more controllers or one or more management nodes for a storage system. The management data logical volume may also be used to consolidate and store process data and to store multiple instances of firmware for the data storage device itself.

### BACKGROUND OF THE INVENTION

1. Field of the Invention

This invention relates to accessing storage system management data and more particularly relates to accessing management data for a storage system on a dedicated management data volume.

2. Description of the Related Art

Computer systems often employ storage systems such as storage servers. Storage systems have high-capacity disk arrays to store and retrieve data for one or more data processing devices such as external host systems. For example, a large corporation or other enterprise may have a network of servers that each store data for a number of workstations used by individual employees or for a plurality of data bases. Storage servers include one or more control modules. The control module may include a processor, memory, and interface logic. The control module controls one or more data storage devices such as high-capacity disk arrays and manages access to the storage devices by one or more data processing devices.

FIG. 1 illustrates an overview of a computer system 100. The computer system 100 includes one or more storage systems 125, which may be Enterprise Storage Servers (“ESS”) manufactured by International Business Machines Corporation (“IBM”) of Armonk, N.Y. A data processing device 110, such as a host server, accesses the storage system 125 through a communication channel 105, such as a shared data network. The storage systems 125 typically can connect to a variety of data processing devices 110, which may be servers that access data for different networks.

Each storage system 125 includes a controller module 115 and one or more data storage devices 120. The data storage devices 120 may be high-capacity disk arrays. The controller module 115 may include a processor, memory, and interface logic. The controller module 115 manages the data storage device 120 and communications with the data processing device 110 using software programs, control parameters, and process data. The processor of the controller module 115 executes the software programs to manage the storage system 125. The software programs are often referred to as firmware. Control parameters may include a plurality of specified data values that may govern data storage device 120 initialization, data storage device 120 rebuilds, and the like. Process data may include process logs, error logs, and the like. The software programs, control parameters, and process data are herein collectively referred to as “management data.”

The controller module 115 typically stores the management data in a nonvolatile memory such as Flash Random Access Memory (“Flash RAM”). The control module 115 may transfer the management data from the Flash RAM to Dynamic Random Access Memory (“DRAM”) on startup. Unfortunately, nonvolatile memory such as Flash RAM is often relatively costly. Therefore the controller module 115 often has only minimal nonvolatile memory sufficient to store one instance of the control modules firmware, basic control parameters, and minimal process data.

The controller module's 115 usability could be enhanced if the controller module 115 was able to store and retrieve more management data. For example, it is often desirable to have controller module 115 return to executing an older instance of firmware in response to various data processing or system administration needs. Unfortunately, because of the limited size of the controller module's 115 nonvolatile memory, often only a single instance of firmware can be stored in the controller module 115. Additional instances of firmware must be managed separately and downloaded to the controller module 115. The limited size of the nonvolatile memory also prevents the controller module 115 from performing other useful memory intensive functions. For example, a first controller module 115a may be prevented from consolidating a first controller module 115a error log with the error log of a second controller module 115b due to a lack sufficient nonvolatile memory in the first controller module 115a.

In addition, the first controller module 115a often lacks sufficient nonvolatile memory to store multiple sets of control parameters, or to store control parameters for the second controller module 115b. Thus, the plurality of controller modules 115 in the storage system 125 is incapable of centrally storing management data. From the foregoing discussion, it should be apparent that a need exists for an apparatus, system, and method that accesses management data from a large capacity storage device. Beneficially, such an apparatus, system, and method would allow the storage and sharing of multiple firmware instances, multiple sets of control parameters, and the consolidation of process data.

### SUMMARY OF THE INVENTION

The present invention has been developed in response to the present state of the art, and in particular, in response to the problems and needs in the art that have not yet been fully solved by currently available storage systems. Accordingly, the present invention has been developed to provide an apparatus, system, and method for accessing management data that overcome many or all of the above-discussed shortcomings in the art.

The apparatus to access management data is provided with a logic unit containing a plurality of modules configured to functionally execute the necessary steps of storing and retrieving management data. These modules in the described embodiments include a first controller module, a user data logical interface module, a management data logical interface module, and a first management application program interface (“API”).

The first controller module manages one or more data storage devices. In one embodiment, the first controller module and the data storage device are included in a storage system. The storage system may store and retrieve data for one or more data processing devices. The data processing devices may be host servers and the like. The first controller module manages the data storage device and communications to and from the data processing device using software programs, control parameters, and process data (“management data”). Using the management data, the first controller module directs retrieving data from and storing data to the data storage device, as well as data maintenance and data storage device maintenance functions.

The data storage device includes at least two data logical volumes, a user data logical volume and a management data logical volume. The user data logical volume stores data from the data processing device such as workstation data backups or data bases. The management data logical volume stores management data used by one or more controller module.

The user data logical interface module communicates the user data between the first controller module and the user data logical volume. The management data is inaccessible through the user data logical interface. For example, a data processing system may not access the management data through the user data logical interface. The management data logical interface communicates the management data between the management data logical volume and a first management application program interface (“API”). The first management API stores and retrieves the management data in the management data logical volume through the management data logical interface. The first controller module may access the management data through the first management API.

In one embodiment, a second controller module accesses the management data of the management data logical volume through a second management API and the management data logical interface. The apparatus stores a larger quantity of management data than may be cost effectively stored in the nonvolatile memory of the first controller module. The management data is accessible through the first management API of the first controller module and the second management API of the second controller module, allowing a plurality of controller modules to access the management data.

A system of the present invention is also presented to access management data. The system may be embodied in a storage system such as an Enterprise Storage Servers (“ESS”) manufactured by International Business Machines Corporation (“IBM”) of Armonk, N.Y. In particular, the system, in one embodiment, includes a data storage device, a communications channel, a first management API, and a first controller module.

The data storage device includes at least two data logical volumes, a user data logical volume and a management data logical volume. The management data logical volume stores management data for the first controller module. While the user data of the user data logical volume may be accessed through the communications channel and thus is accessible to one or more data processing devices such as host servers, the management data of the management data logical volume is only accessible through a management API such as the first management API of the first controller module.

In one embodiment, the first controller module may store multiple instances of firmware in the management data logical volume through the first management API. In an alternate embodiment, the first controller module may consolidate the process data such as error logs of the first controller module and a second controller module and store the consolidated process data on the management data logical volume through the first management API. The second controller module may also access control parameters such as configuration parameters stored on the management data logical volume through a second management API of the second controller module.

In one embodiment, the management API resides on a management node. The management node may provide a control interface for one or more control modules. The management node may access the management data through the management API.

A method of the present invention is also presented for accessing management data. The method in the disclosed embodiments substantially includes the steps necessary to carry out the functions presented above with respect to the operation of the described apparatus and system. In one embodiment, the method includes creating a management data logical volume and a user data logical volume, storing management data to the management data logical volume, retrieving the management data from the management data logical volume through a first management API, and managing a storage system using the management data. The method also may include accessing the management data through a second management API.

The method creates a management data logical volume and a user data logical volume on a data storage device. The user data logical volume contains user data and is accessible through a user data logical interface. For example, a data processing device may access the user data of the user data logical volume. The management data logical volume is accessible through a management data logical interface and is inaccessible through the user data logical interface. The management data logical interface is only accessed through the management API.

The method stores management data to the management data logical volume through the management data logical interface and the management API. For example, the method may store a firmware instance in the management data logical volume. In addition, the method retrieves the management data from the management data logical volume through the management data logical interface the management API. In one embodiment, the method retrieves control parameters such as configuration parameters for a first and a second controller module. The method further directs the first controller module to manage the data storage device responsive to the management data. For example, the method may direct the first controller module to retrieve and execute a specified firmware instance.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention stores and retrieves management data in a dedicated management data logical volume of a data storage device through a management API. The present invention allows a management node or a controller module to store and retrieve larger quantities of management data, and share the management data with and consolidate the management data from additional management nodes and controller modules. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a computer system of the current practice;

FIG. 2 is a schematic block diagram illustrating one embodiment of a computer system of the present invention;

FIG. 3 is a schematic block diagram illustrating one embodiment of a management data apparatus in accordance with the present invention;

FIG. 4 is a schematic block diagram illustrating one embodiment of a management data system of the present invention;

FIG. 5 is a schematic flow chart diagram illustrating one embodiment of a management data method in accordance with the present invention;

FIG. 6 is a schematic flow chart diagram illustrating one embodiment of a multiple firmware storage method in accordance with the present invention;

FIG. 7 is a schematic flow chart diagram illustrating one embodiment of a management data write method of the present invention;

FIG. 8 is a schematic flow chart diagram illustrating one embodiment of a management data read method of the present invention; and

FIG. 9 is a schematic block diagram illustrating one embodiment of a management data storage device in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

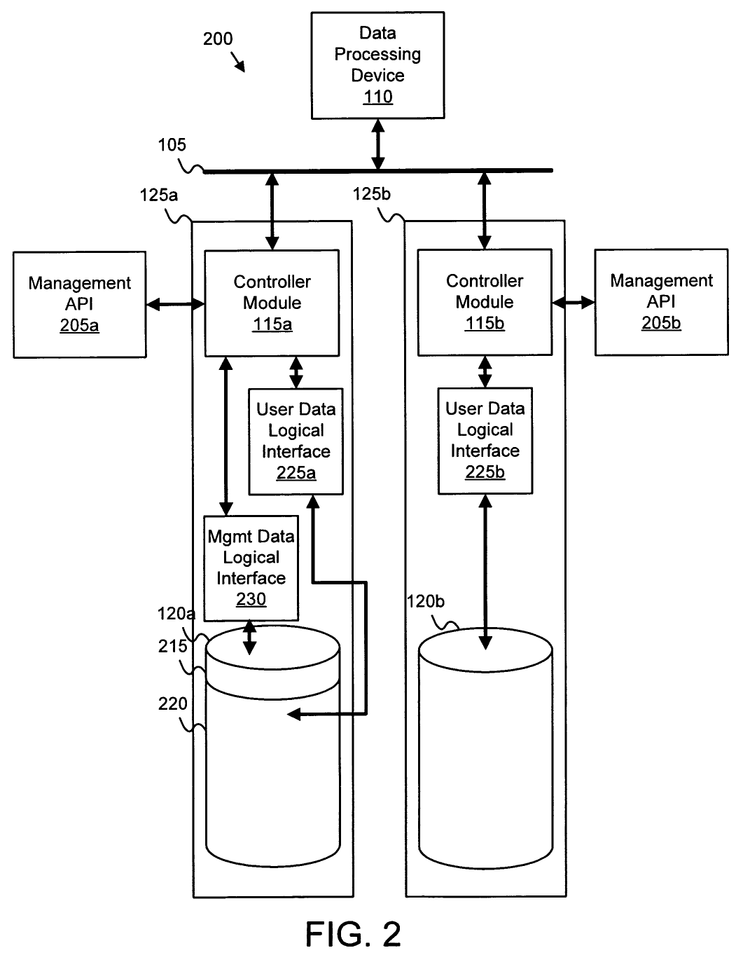

FIG. 2 illustrates one embodiment of a computer system 200 of the present invention. The computer system 200 may be embodied in a storage system such as an Enterprise Storage Servers (“ESS”) manufactured by International Business Machines Corporation (“IBM”) of Armonk, N.Y. In the depicted embodiment, the computer system 200 includes a data processing device 110, a communications channel 105, one or more storage systems 125, one or more controller modules 115, one or more data storage devices 120, one or more management application program interfaces (“API”) 205, one or more user data logical interfaces 225, and a management data logical interface 230. Although the storage system 125 is depicted with one data storage device 120, the storage system 125 may include any number of data storage devices 120.

The storage system 125 communicates with the data processing device 110 through the communications channel 105. The storage system 125 may retrieve and store data for the data processing device 110. In one embodiment, the data processing device 110 is a host server. The storage system 125 comprises the controller module 115 and the data storage device 120. The controller module 115 manages the storage and retrieval of data between the communication channel 105 and the data storage device 120. The data storage device 120 may be a hard disk, an array of hard disks, a random array of independent disks (“RAID”), and the like.

The controller module 115 manages the data storage device 120 and communications with the data processing device 110 using software programs, control parameters, and process data (“management data”). Management data may include but is not limited to firmware executed by the controller module 115, parameters for controller module 115 functions such as initializing the data storage device 120, and error logs. The controller module 115 uses the management data to direct retrieving data from and storing data to the data storage device 120, as well as data maintenance and data storage device 120 maintenance functions such as data mirroring and data scrubbing.

The controller module 115 of the current practice typically stored all the management data in non-volatile memory. Unfortunately, management data may exceed the storage space of non-volatile memory. To increase management data storage, the computer system 200 creates additional storage for the management data.

The first data storage device 120a includes at least two data logical volumes, a user data logical volume 220 and a management data logical volume 215. In one embodiment, the user data logical volume 220 and the management data logical volume 215 reside on a common disk drive. The user data of the user data logical volume 220 may include but is not limited to workstation backup data, transaction processing data, and data bases. The controller module 115 accesses the user data logical volume 220 through the user data logical interface 225.

The management data logical volume 215 stores management data for the first controller module 115a. The management data of the management data logical volume 215 is only accessible through the management API 205 such as the first management API 205a of the first controller module 115a and through the management data logical interface 230. In one embodiment, the first management API 205a may store multiple instances of firmware in the management data logical volume 215. In an alternate embodiment, the first controller module 115a may consolidate the process data such as error logs of the first controller module 115a and the second controller module 115b and store the consolidated process data through the first management API 205a on the management data logical volume 215.

The second management API 205b may also access control parameters such as configuration parameters stored on the management data logical volume 215 for the second controller module 115b. For example, the second management API 205b may retrieve parameters for initializing the second data storage device 120b from the management data logical volume 215. In one embodiment, the second management API 205b accesses the management data logical volume 215 through the first management API 205a. The computer system 200 stores and retrieves management data for managing one or more storage systems 125 though the management API 205 to the management data logical volume 215.

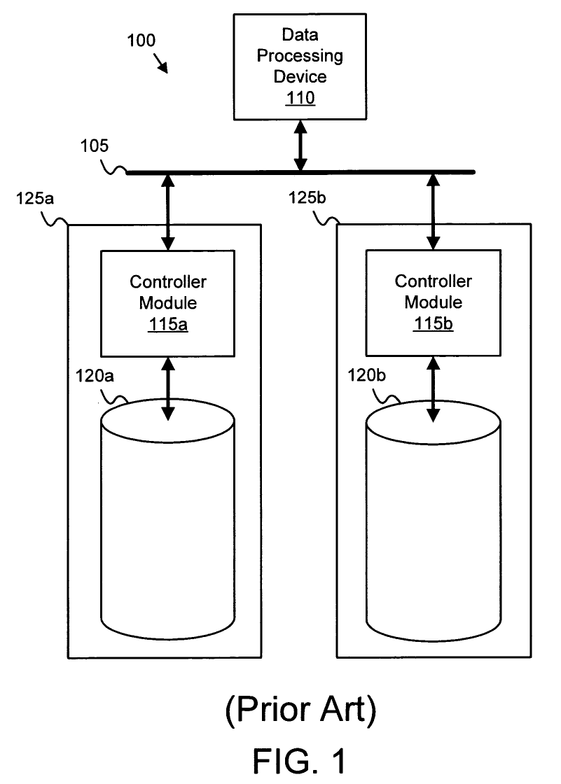

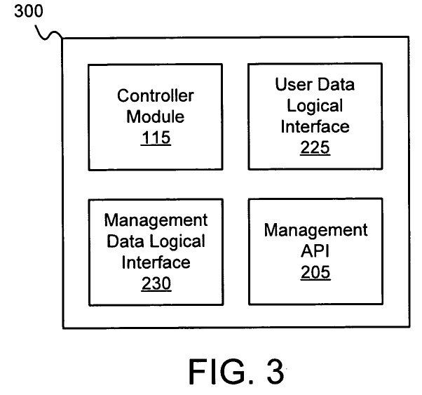

FIG. 3 is a schematic block diagram illustrating one embodiment of a management data apparatus 300. The controller module 115 manages one or more data storage devices 120. In one embodiment, the controller module 115 and the data storage device 120 are included in a storage system 125 such as the storage system 125 of FIG. 1. The management data apparatus 300 includes at least two data logical volumes, a user data logical volume 220 and a management data logical volume 215. The management data logical volume 215 stores management data such as management data used by the controller module 115.

The management API 205 accesses the management data of the management data logical volume 215 through the management data logical interface 230. The management data of the management data apparatus 300 is accessed only through the management data logical interface 230, although the management data logical interface 230 may share software layers and physical communication channels with the user data logical interface 225 that stores and retrieves user data in the user data logical volume 220. In one embodiment, the management API 205 accesses the management data logical interface 230 through a controller API configured to communicate with the controller module 115. The controller API may communicate with both the user data logical interface 225 and the management data logical interface 230. In an alternate embodiment, the controller API may communicate exclusively with the management data logical interface 230.

In one embodiment, the management data logical interface 230 communicates with the management data logical volume 215 over a physical communications channel. In a certain embodiment, the physical communications channel is an electronic data bus. The physical communications channel may also be a point-to-point electronic communications line. In one embodiment, the physical communications channel is used by the user data logical interface 225 and the management data logical interface 230. In an alternate embodiment, the physical communications channel is used exclusively by the management data logical interface 230. The management data apparatus 300 accesses management data from the management data logical volume 215 through the management API 205 and the management data logical interface 230.

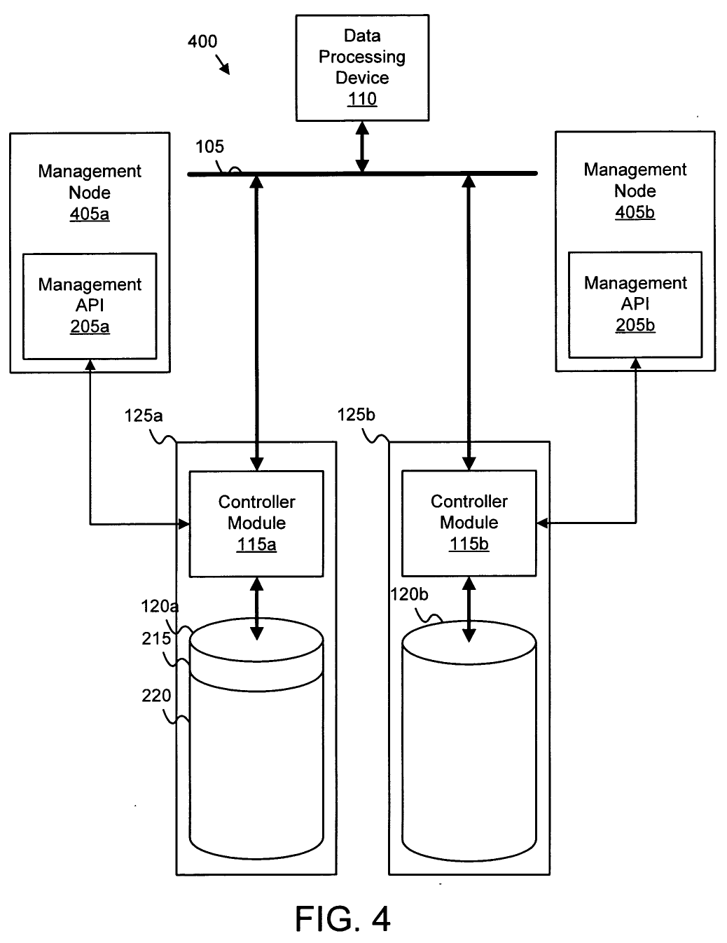

FIG. 4 is a schematic block diagram illustrating one embodiment of a management data system 400 of the present invention. The management data system 400 accesses management data used to manage one or more storage systems 125 from a management data logical volume 215. The management data system 400 includes one or more management nodes 405. The management node 405 may manage the controller module 115 of the storage system 125. In an alternate embodiment, the management node 405 is included in the controller module 115. Although the management data system 400 depicts one management node 405 for each storage system 125, each management node 405 may manage any number of storage systems 125.

The first management node 405a and the second management node 405b may each access the management data logical volume 215. The first management node 405a may access the management data logical volume 215 through the first management API 205a. In one embodiment, the second management node 405b accesses the management data logical volume 215 through the second management API 205b. In an alternate embodiment, the second management API 205b accesses the management data logical volume 215 through the first management API 205a. Although the first and second management API 205a, 205b may reside and/or execute on separate modules, in one embodiment, the first and second management API 205a, 205b comprise the same software process.

The management data logical volume 215 may store management data for a plurality of management nodes 405. For example, the management data logical volume 215 may store multiple instances of firmware such as firmware for the controller module 115. Each instance of firmware may be stored to the management data logical volume 215 from the communication channel 105. The second management node 405b may retrieve a specified firmware instance from the management data logical volume 215 for the second controller module 115b through the second management API 205b. The management data system 400 may store the multiple instances of firmware, making each instance accessible to each management node 405.

The management node 405 may also consolidate process data in the management data logical volume 215. For example, the first and second management node 405a, 405b may each receive process data such as error log data from the first and second storage systems 125. The first management node 405a may consolidate the error logs and store the error logs on the management data logical volume 215. In an alternate embodiment, the first management node 405a may consolidate and store transaction logs on the management data logical volume 215.

In one embodiment, the management node 405 includes a user interface. A user may control one or more storage systems 125 through the user interface of the management node 405. The management data logical volume 215 may store management data such as the user interface software. One more or more management nodes 405 may retrieve the user interface software from the management data logical volume 215. For example, each management node 405 may update the management node's 405 user interface by accessing the user interface software of the management data logical volume 215 through the management API 205. The management data system 400 stores and retrieves management data used by one or more management nodes 405 using the management API 205.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbology employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

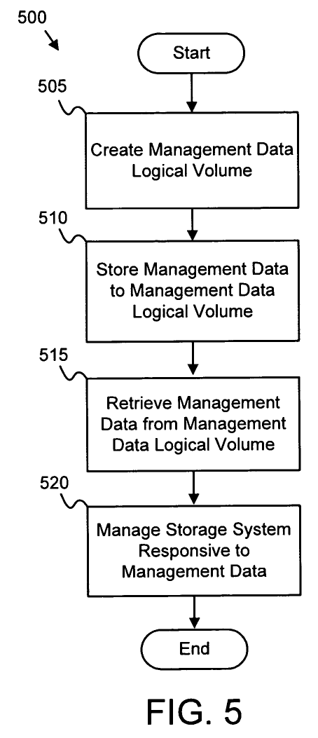

FIG. 5 is a schematic flow chart diagram illustrating one embodiment of a management data method 500 of the present invention. The controller module 115 creates 505 a management data logical volume 215 on a data storage device 120 that includes a user data logical volume 220. In one embodiment, the controller module 115 creates 505 the management data logical volume 215 by partitioning a portion of the user data logical volume 220. In an alternate embodiment, the controller module 115 creates 505 the management data logical volume 215 by establishing a hidden file on the user data logical volume 220. In a certain embodiment, the management node 405 directs the controller module 115 to create 505 the management data logical volume 215.

The user data logical volume 220 contains user data and is accessible through a user data logical interface 225. For example, a data processing device 110 such as a transaction server may access the user data such as transaction data on the user data logical volume 220 through the user data logical interface 225. In addition, the management data logical volume 215 is accessible through the management data logical interface 230 and the management API 205 and is inaccessible through the user data logical interface 225. The management data logical interface 230 is only accessed through the management API 205.

The controller module 115 stores 510 management data to the management data logical volume 215 through the management API 205 and the management data logical interface 230. For example, the controller module 115 may store 510 process logs through the management API 205 and the management data logical interface 230 to the management data logical volume 215. In addition, the controller module 115 retrieves 515 the management data from the management data logical volume 215 through the management API 205 and the management data logical interface 230. In one embodiment, a first controller module 115a retrieves 515 control parameters such as configuration parameters for the first controller module 115a and a second controller module 115b.

The controller module 115 manages 520 the storage system 125 responsive to the management data. In one embodiment, the management node 405 manages 520 the storage system 125. For example, the management node 405 may retrieve 510 a specified firmware instance and execute the specified firmware instance on the controller module 115. The controller module 115 stores 505 and retrieves 510 management data and manages 520 the storage system 125 using the management data.

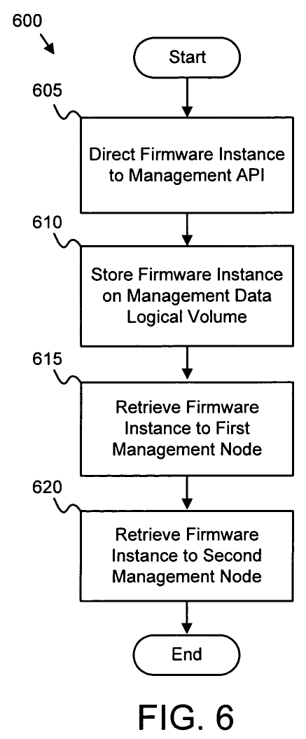

FIG. 6 is a schematic flow chart diagram illustrating one embodiment of a multiple firmware storage method 600 of the present invention. A data processing device 110 directs 605 a plurality of firmware instances to the management API 205. The data processing device 110 may be host device such as mainframe computer. In one embodiment, each firmware instance is a distinct revision of firmware, such as the multiple revisions of successive firmware releases. The firmware may be the management node 405 firmware. In a certain embodiment, the firmware is the controller module 115 firmware.

The controller module 115 stores 610 the firmware instances to the management data logical volume 215 through the management API 205 and the management data logical interface 230. In one embodiment, the management node 405 directs the controller module 115 to store 610 the firmware instances. In addition, the controller module 115 may retrieve 615 a specified firmware instance from the management data logical volume 215 through the management API 205 and the management data logical interface 230 to the first management node 405a. In a certain embodiment, the management node 405 directs the controller module 115 to retrieve 615 the specified firmware instance. In one embodiment, the specified firmware instance is a firmware upgrade. For example, the controller module 115 may retrieve 615 the specified firmware instance as a firmware upgrade for to the first management node 405a in the management data system 400 depicted in FIG. 4. In addition, the controller module 115 may retrieve 620 the specified firmware to a second management node 405b. The controller module 115 may upgrade the firmware of a plurality of management nodes 405 from a single management data logical volume 215.

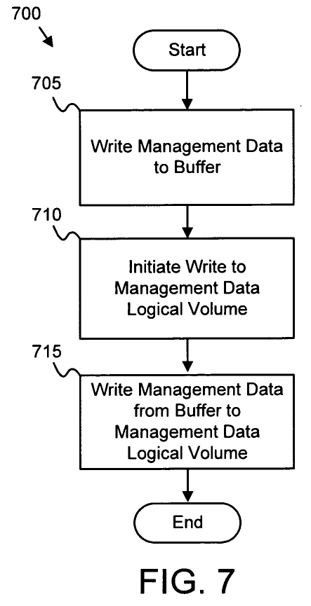

FIG. 7 is a schematic flow chart diagram illustrating one embodiment of a management data write method 700 of the present invention. The management node 405 writes management data to a buffer. In one embodiment, the management node 405 writes management data to the buffer in response to a command from a data processing device 110. The buffer may comprise the controller module 115. The management node 405 initiates 710 writing the management data in the buffer to the management data logical volume 215. In one embodiment, the management node 405 initiates 710 the write by directing the controller module 115 to write the management data from the buffer to the management data logical volume 215. The controller module 115 writes 715 the management data from the buffer to the management data logical volume 215 and the method 700 terminates.

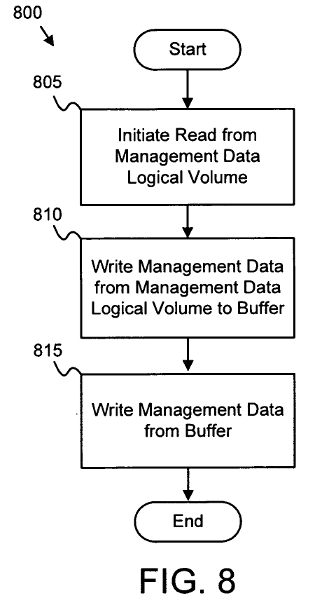

FIG. 8 is a schematic flow chart diagram illustrating one embodiment of a management data read method 800 of the present invention. The management node 405 initiates 805 reading specified management data from the management data logical volume 215. In one embodiment, the management node 405 initiates 805 the read by directing the controller module 115 to read the specified management data from the management data logical volume 215. The controller module 115 writes 810 the specified management data from the management data logical volume 215 to a buffer. The controller module 115 may comprise the buffer. In addition, the controller module 115 writes 815 the management data from the buffer to a target device such as the controller module 115.

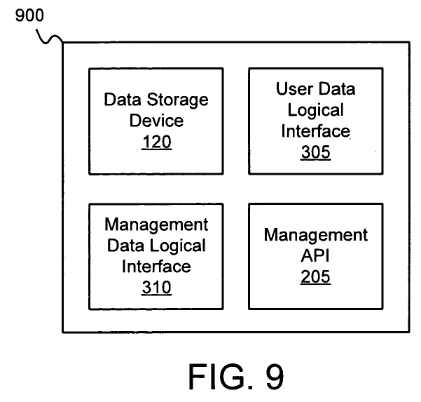

FIG. 9 is a schematic block diagram illustrating one embodiment of a management data storage device 900 in accordance with the present invention. The management data storage device 900 includes a data storage device 120. The data storage device 120 includes a user data logical volume 220 and a management data logical volume 215. The user data logical volume 220 may be accessed directly by communicating with the management data storage device 900. The management data logical volume 215 may only be accessed through the management API 205.

For example, the management data storage device 900 may be in communication with a data processing device 110. The data processing device 110 may store and retrieve data to the user data logical volume 220 of the data storage device 120. The data processing device 110 may also store and retrieve management data to the management data logical volume 215 through the management API 205. The management data logical volume 215 is only accessible through the management API 205. Thus a first application executing on the data processing device 110 such as a user application may not access the management data logical volume 215 if the first application lacks an interface to management API 205. A second application with the interface to the management API 205 may access the management data logical volume 215 through the management API 205.

The present invention stores and retrieves management data in a dedicated management data logical volume 215 of a data storage device 120 through a management API 205. The present invention allows a management node 405 or a controller module 115 to store and retrieve larger quantities of management data, and share the management data with and consolidate the management data from additional management nodes 405 and controller modules 115. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for accessing management data, the apparatus comprising:
a controller module configured to manage a data storage device responsive to management data and retrieve and store data to the data storage device, the data storage device configured to retrieve and store user data in a user data logical volume and to retrieve and store management data in a management data logical volume;
a user data logical interface module configured to communicate the user data between the controller module and the user data logical volume, wherein in the management data is inaccessible through the user data logical interface;
a management data logical interface module configured to communicate the management data between the controller module and the management data volume, wherein the user data is inaccessible through the management data logical interface; and
a first management application program interface (“API”) configured to store and retrieve the management data in the management data logical volume through the management data logical interface module.

2. The apparatus of claim 1, further comprising a second management API configured to store and retrieve the management data in the management data logical volume through the management data logical interface module and the controller module.

3. The apparatus of claim 2, wherein the first management API is further configured to consolidate a plurality of files from a plurality of controller modules.

4. The apparatus of claim 1, further comprising a management module in communication with the controller module and comprising the first management API.

5. The apparatus of claim 4, wherein the management data comprises the management module configuration data.

6. The apparatus of claim 4, wherein the management module is further configured to adjust the size of the allocation of the management data logical volume on the data storage device.

7. The apparatus of claim 1, wherein the management data comprises a controller firmware module.

8. The apparatus of claim 7, wherein the management data comprises a plurality of controller firmware modules.

9. A management data storage device, the device comprising:
a data storage device configured as a user data logical volume and a management data logical volume;
a user data logical interface module configured to store and retrieve user data between the user data logical volume and a controller;
a management data logical interface module configured to store and retrieve management data between the management data logical volume and a controller, the management data logical volume inaccessible through the user data logical interface module; and
a management API configured to store and retrieve the management data in the management data logical volume through the management logical interface module.

10. A system for accessing management data, the system comprising:
a data storage device configured to store and retrieve user data in a user data logical volume and management data in a management data logical volume;
a communications channel in communications with a data processing device;
a first management API configured to retrieve and store the management data in the management data logical volume;
a controller module configured to manage the data storage device responsive to the management data retrieved and stored by the first management API and communicate the user data between the communications channel and the user data logical volume.

11. The system of claim 10, further comprising a second management API configured to store and retrieve the management data in the management data logical volume through the controller module.

12. The system of claim 11, wherein the first management API is further configured to consolidate a plurality of files from a plurality of controller modules.

13. The system of claim 10, further comprising a management module in communication with the controller module and comprising the first management API.

14. The system of claim 10, wherein the management module is further configured to manage a plurality of controller modules configured to control a plurality of data storage devices.

15. The system of claim 10, wherein the management data comprises the controller module configuration data.

16. The system of claim 10, wherein the management API is further configured to adjust the size of the allocation of management data logical volume on the data storage device.

17. The system of claim 10, wherein the management data comprises a controller firmware module.

18. The system of claim 10, wherein the management data comprises a plurality of controller firmware modules.

19. The system of claim 10, wherein the data storage device is configured as a network attached data storage device.

20. A signal bearing medium tangibly embodying a program of machine-readable instructions executable by a digital processing apparatus to perform operations to access management data, the operations comprising:
creating a management data logical volume and a user data logical volume on a data storage device, the user data logical volume accessible through a user data logical interface, the management logical volume accessible through a management data logical interface and inaccessible through the user data logical interface;
storing management data to the management data logical volume through the management data logical interface under the direction of a management API;
retrieving the management data from the management data logical volume through the management data logical interface under the direction of a management API; and
managing a storage system using the management data.

21. The signal bearing medium of claim 20, wherein the instructions further comprise operations to store and retrieve the management data in the management data logical volume through the management data logical interface module and the controller module under the direction of a second management API.

22. The signal bearing medium of claim 20, wherein the instructions further comprise operations to initialize the controller module using the management data of the management data logical volume.

23. The signal bearing medium of claim 20, wherein the instructions further comprise operations to consolidate a plurality of files from a plurality of controller modules.

24. The signal bearing medium of claim 20, wherein the instructions further comprise operations to configure the controller module with the management data.

25. The signal bearing medium of claim 20, wherein the instructions further comprise operations to adjust the size of the allocation of the management data logical volume on the data storage device.

26. The signal bearing medium of claim 25, wherein the instructions further comprise operations to adjust the size of the allocation of the management data logical volume responsive to user input.

27. A method for accessing management data, the method comprising:
creating a management data logical volume and a user data logical volume on a data storage device, the user data logical volume accessible through a user data logical interface, the management logical volume accessible through a management data logical interface and inaccessible through the user data logical interface;
storing management data to the management data logical volume through the management data logical interface under the direction of a management API;
retrieving the management data from the management data logical volume through the management data logical interface under the direction of a management API; and
managing a storage system using the management data.

28. The method of claim 27, further comprising storing and retrieving the management data in the management data logical volume through the management data logical interface module and the controller module under the direction of a second management API.

29. The method of claim 27, further comprising configuring the controller module with the management data.

30. An apparatus for accessing management data, the apparatus comprising:
means for creating a management data logical volume and a user data logical volume on a data storage device, the user data logical volume accessible through a user data logical interface, the management logical volume accessible through a management data logical interface and inaccessible through the user data logical interface;
means for storing management data to the management data logical volume through the management data logical interface under the direction of a management API;
means for retrieving the management data from the management data logical volume through the management data logical interface under the direction of a management API; and
means for managing a storage system using the management data.
